(19) United States
(12) Patent Application Publication
(10) Pub. No.: US 2022/0281739 A1
(43) Pub. Date: Sep. 8, 2022

(54) SAFETY CINCH FOR SADDLES

(71) Applicant: Andrew Dale Baltes, Riverton, WY (US)

(72) Inventor: Andrew Dale Baltes, Riverton, WY (US)

(21) Appl. No.: 17/689,637

(22) Filed: Mar. 8, 2022

Related U.S. Application Data
(60) Provisional application No. 63/158,182, filed on Mar. 8, 2021.

(51) Int. Cl. B68C 1/14

(52) U.S. Cl. CPC B68C 1/147; B68C 2001/142

(57) ABSTRACT

A safety cinch for use with a saddle. The safety cinch includes a first layer of material and a securing device connectable to a saddle connector. The safety cinch also includes a latch apparatus that can selectively engage the securing device and a wireless receiver that can send a signal to the latch apparatus to disengage from the securing device to unsecure a saddle from an animal. A method of dislodging a saddle from a horse via a remote control via the step of actuating the remote control to activate the safety cinch.

### STATEMENT REGARDING FEDERALLY SPONSORED RESEARCH OR DEVELOPMENT

Not applicable.

### CROSS-REFERENCE TO RELATED APPLICATIONS

The present application is a conversion of U.S. Provisional application having U.S. Ser. No. 63/158,182, filed Mar. 8, 2022, which claims the benefit under 35 U.S.C. 119(e). The disclosure of which is hereby expressly incorporated herein by reference.

### BACKGROUND OF THE DISCLOSURE

### 1. Field of the Invention

The present disclosure relates to a safety cinch (or girth) for use with a saddle to allow for a quick release of a saddle from a horse in an emergency situation.

### 2. Description of the Related Art

A typical cinch runs on the underside of a horse, or some other ridable animal such as a bull, mule, camel, etc., and extends from one side of a saddle to another to help secure the saddle to the back of the horse. The cinch is securely buckled to the saddle on both sides. In certain situations, a saddle being secured to a horse can be dangerous to the rider. For example, a horse could get spooked and react, which could cause a rider to fall off. Sometimes, a rider can get hung up in the saddle and dragged by the horse. A rider can be seriously injured when they get hung in a saddle.

Accordingly, there is a need for a device or system that allows a rider to release the saddle from the horse that is dragging the rider.

### SUMMARY OF THE DISCLOSURE

The present disclosure is directed toward a safety cinch for use with a saddle. The safety cinch includes a first layer of material and a securing device connectable to a saddle connector. The safety cinch also includes a latch apparatus that can selectively engage the securing device and a wireless receiver that can send a signal to the latch apparatus to disengage from the securing device to unsecure a saddle from an animal.

The present disclosure is also directed to a method of dislodging a saddle from a horse via a remote control. The method includes the step of actuating the remote control to activate the safety cinch.

### BRIEF DESCRIPTION OF THE DRAWINGS

FIG. 1 is a perspective view of a saddle with a safety cinch constructed in accordance with the present disclosure.

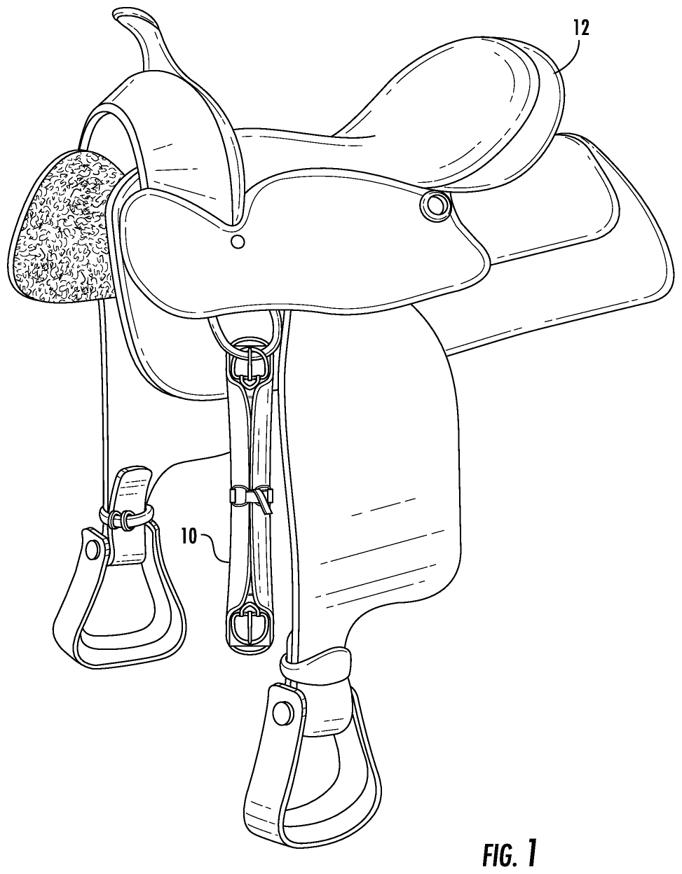

FIG. 2 is a top plan view of the safety cinch in an open configuration constructed in accordance with the present disclosure.

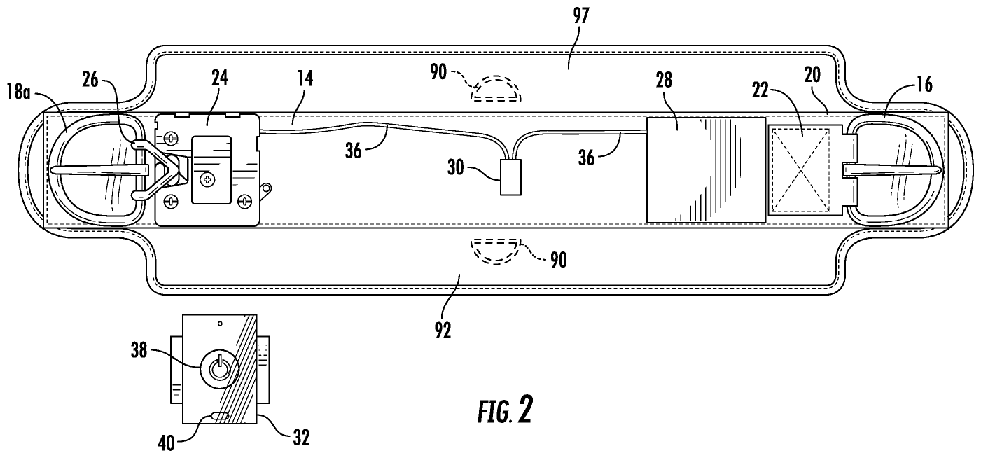

FIGS. 3A-3B are perspective views of a portion of the safety cinch in a closed position and constructed in accordance with the present disclosure.

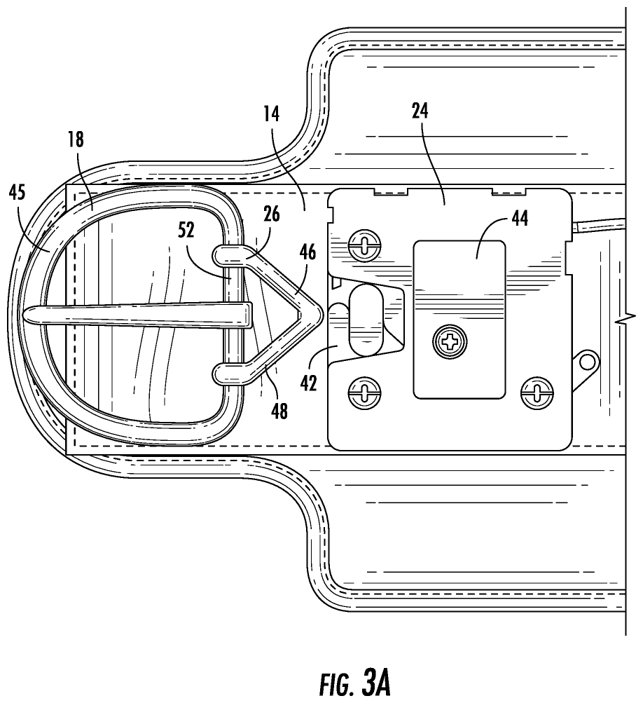

FIG. 4 is a perspective view of the portion of the safety switch shown in FIGS. 3A-3B and constructed in accordance with the present disclosure.

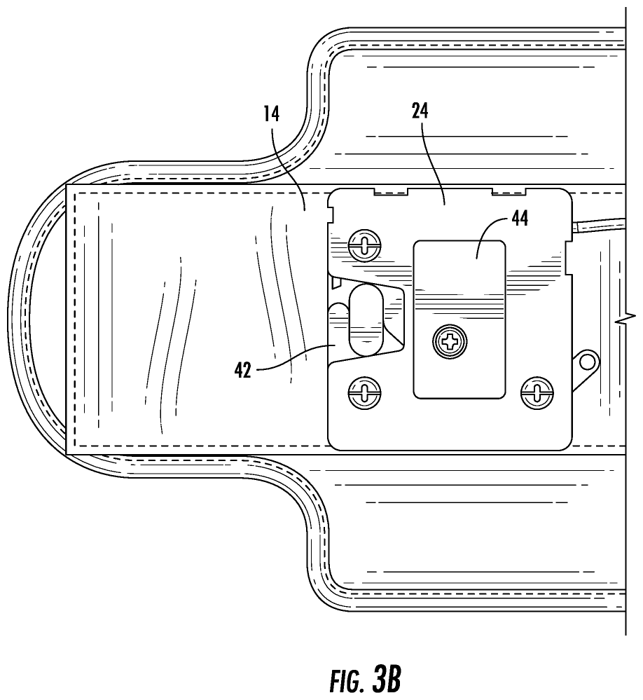

FIGS. 5A-5B are side elevation views of various portions of the safety cinch constructed in accordance with the present disclosure.

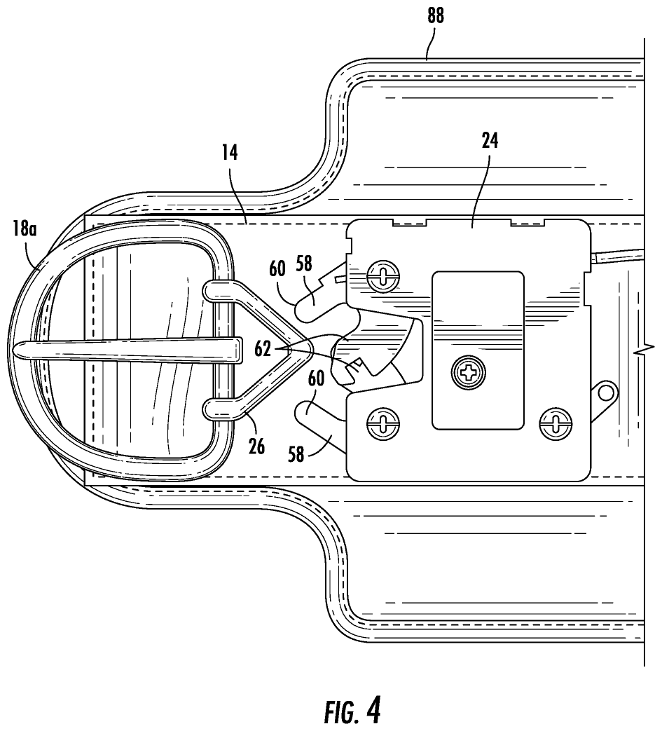

FIG. 6 is a side elevation view of a portion of another embodiment of the safety cinch constructed in accordance with the present disclosure.

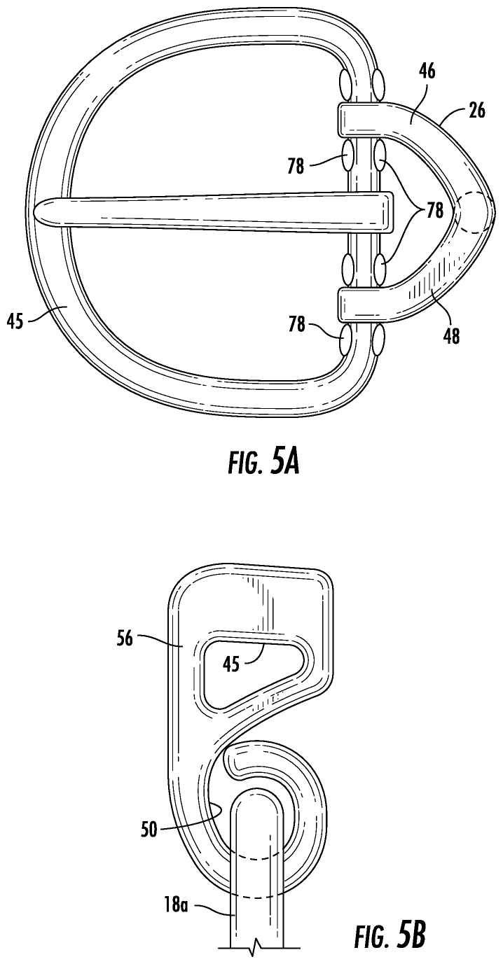

FIG. 7 is a top plan view of the safety cinch in an closed configuration constructed in accordance with the present disclosure

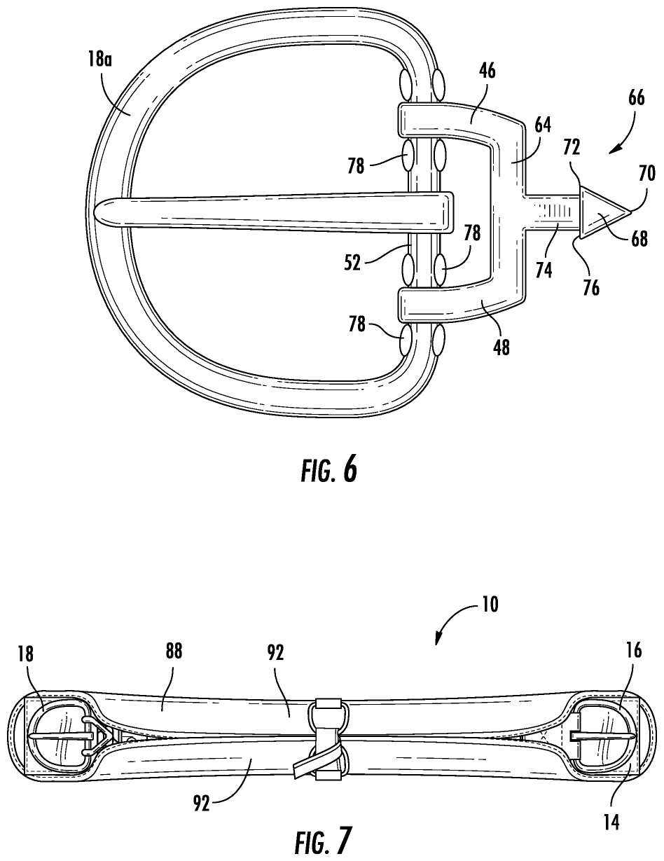

FIG. 8 is a top plan view of a European saddle buckle usable with the safety cinch constructed in accordance with the present disclosure.

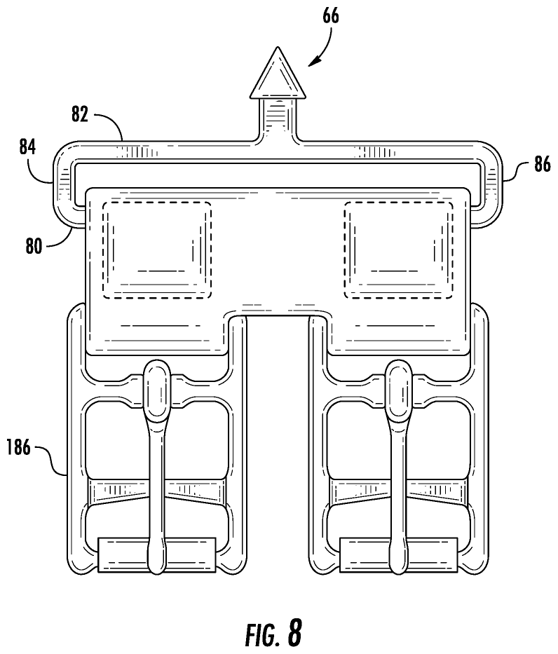

### DETAILED DESCRIPTION OF THE DISCLOSURE

The present disclosure relates to a safety cinch 10 for use with a saddle 12 to allow a quick release of the saddle 12 in emergency situations or in other situations, such as training situations. The safety cinch 10 can be designed for different types of saddles 12, such as for an English saddle or a Western saddle, or to be used with a rigging. The safety cinch 10 includes a first layer of material 14 that is durable enough to handle the stresses applied to a cinch and a first saddle connector 16 and a second saddle connector 18 used to secure the safety cinch 10 to the saddle 12. For example, the first layer of material 14 can be a polyester webbing. The first and second saddle connectors 16 and 18 can be different, depending on the type of saddle 12. For Western saddles, each of the first and second saddle connectors 16 and 18 are single D-rings. For English saddles, each of the first and second saddle connectors 16 and 18 are pairs of smaller buckles. The first saddle connector 16 is secured to a first end 20 of the first layer of material 14 via any means known in the art. For example, the first saddle connector 16 can be secured to first end 20 of the first layer of material 14 via engagement with a piece of material 22 and stitching the piece of material 22 to the first layer of material 14 of the safety cinch 10.

The safety cinch 10 can also include a latch apparatus 24 that can engage with a securing device 26 that is attached to the second saddle connector 18, a power supply 28 (a battery for example) for providing power to the safety cinch 10, a wireless receiver 30 to receive signals from a remote control 32 carried by the rider of the horse and/or some other individual(s), and a communication link 34 for transmitting operational signals to the latch apparatus 24. The communication link 34 can be wired or wireless. In one embodiment, wires 36 connect the power supply 28 to the latch apparatus 24 wherein the wireless receiver 30 controls whether the latch apparatus 24 receives power from the power supply 28. The safety cinch 10 can also be setup where the receiver 30 sends a signal to the latch apparatus 24 to operate the latch apparatus 24 via wireless communication. In this embodiment, the latch apparatus 24 can have its own power supply.

The latch apparatus 24, the wireless receiver 30, the power supply 28, and the communication link 34, if wired, are all secured to the first layer of material 14. All parts of the safety cinch 10 can be waterproofed to guard against sweat from the animal. The wireless receiver 30 is designed to receive signals from the remote control 32 carried by the horse rider. The remote control 32 can be worn on a lanyard or on a rider's wrist and have a button 38 that the rider, or some other individual, can push. The button 38 can cause the latch apparatus 24 to engage and disengage the securing device 26 attached to the second saddle connector 18. The remote control 32 and the wireless receiver 30 include all requisite hardware and software to facilitate the operability of the remote control 32 and the wireless receiver 30. The power supply 28 can be a battery or a rechargeable battery. In one embodiment, the remote control 32 can have additional buttons to perform additional tasks. For example, the button 38 can be the primary button that causes the latch apparatus 24 to disengage the securing device 26. The remote control 32 can also include a secondary button 40 that can cause the latch apparatus 24 to engage the securing device 26.

The latch apparatus 24 can include a latching mechanism 42 that selectively engages with the securing device 26 coupled to the second saddle connector 18 and an actuator 44 in electronic communication with the wireless receiver 30 to activate the latching mechanism 42 to switch between an open and closed position. When the latching mechanism 42 is in the closed position, the latching mechanism 42 securely engages the securing device 26 and the safety cinch 10 operates to secure the saddle to the animal (e.g., horse). Conversely, when the latching mechanism 42 is in the open position, the latching mechanism 42 releases the securing device 26, which permits the saddle 12 to come unsecured from the animal.

In one embodiment of the present disclosure, the securing device 26 secured to the second saddle connector 18 can be a U-shaped device 45 having a first leg 46 and a second leg 48. The first and second legs 46 and 48 have laterally disposed holes 50 therein to engage a straight side of the D-ring style second saddle connector 18a. The laterally disposed holes 50 in the first and second legs 46 and 48 of the U-shaped device 45 can be created by wrapping the first and second legs 46 and 48 around a straight side 52 of the D-ring style second saddle connector 18a. The U-shaped device 45 can also include an opening 54 in a crown part 56 of the U-shaped device 45 where the latching mechanism 42 engages the securing device 26. In this embodiment, the latching mechanism 42 can be two offset, C-shaped brackets 58 that come together to engage the opening 54 in the crown part 56 of the U-shaped device 45. This is essentially a rotary latch. A first leg 60 of each C-shaped bracket 58 that is closest to the securing device 26 extends through the opening 54 in the crown part 56 of the U-shaped device 45 and overlap with a second leg 62 in the opening 54 in the crown part 56 to secure the safety cinch 10 in place. It should be understood and appreciated that the C-shaped brackets 58 can have curved features or it can have hard edges and corners. It should be understood and appreciated that the securing device 26 can have any shape such that it can be secured to the second saddle connector 18 and selectively and securely engaged by the latching mechanism 42 of the latch apparatus 24.

In yet another embodiment of the present disclosure, the U-shaped device 45 can have a cross bar 64 attached to and extending between the first and second legs 46 and 48. A pin latch 66 can be attached to the cross bar 64 to engage with the latching mechanism 42 to provide for secure attachment. The pin latch 66 can include an insertion end 68 where the tip 70 of the insertion end 70 allows for easy insertion of the pin latch 66 into the latch apparatus 34 and a base part 72 that is wider than the tip 70. The pin latch 66 can also include an engagement area 74 where the latching mechanism 42 engages the pin latch 66. The engagement area 74 is narrower than the base part 72 of the insertion end 68 which creates a shoulder 76 that the latching mechanism 42 engages with. In this embodiment, the latching mechanism 42 can include any type of brackets that can engage the engagement area 74 of the pin latch 66 and prevent the securing device 26, and thus the second saddle connector 18, from disengaging from the latch apparatus 24 unless desired by the rider.

The D-ring style second saddle connector 18a can include protrusions 78 on the straight side 52 of the D-ring style second saddle connector 18a to prevent movement of the first and second legs 46 and 48 of the securing device 26, and thus the securing device 26, along the straight side 52 of the D-ring style second saddle connector 18a. The protrusions 78 can be located anywhere on the straight side 52 of the D-ring style second saddle connector 18a so as to prevent movement of the securing device 26 along the straight side 52 of the D-ring style second saddle connector 18a. In one embodiment, there is at least one protrusion 78 disposed on each side of the first leg 46 and each side of the second leg 48 of the U-shaped device 45. In a further embodiment, there can be more than one protrusion 78 disposed on each side of the first leg 46 and each side of the second leg 48 of the U-shaped device 45.

When the second saddle connector 18 is that used for an English saddle, the securing device 26 can include a first cross bar 80 that is secured to a two-buckle type second saddle connector 18b and a second cross bar 82 that supports a pin latch 66 like that disclosed herein. The first and second cross bars 80 and 82 are connected by a first leg 84 and a second leg 86. The first cross bar 80 can be secured to the two-buckle type second saddle connector 18b in any manner known in the art so that the two-buckle type second saddle connector 18b can still operate as intended with the saddle 12. In one embodiment, the two-buckle type second saddle connector 18b can be secured to the first cross bar 80 via material that extends from the two-buckle type second saddle connector 18b and around the first cross bar 80.

The safety cinch 10 can be provided with a second sheet of material 88 to which the first sheet of material 14 is secured. The second sheet of material 88 can encapsulate all the other components of the safety cinch 10 and be secured to itself. The second sheet of material 88 will actually come in contact with the animal and thus needs to be comfortable and not abrasive. In one embodiment, the second sheet of material 88 can be neoprene. The second sheet of material 88 can also protect the other components of the safety cinch 10. A hole 90 can be cut in the second sheet of material 88 with a flap 92 over the hole 90, wherein the flap 92 is selectively securable to the second layer of material 88, such as via hook and loop. In one embodiment, the only parts visible and accessible from the second layer of material 88 are the first and second saddle connectors 16 and 18. Parts of the first layer of material 14 may be visible beneath the first and second saddle connectors 14.

The present disclosure is also directed to a method of dislodging the saddle 12 from an animal via the remote control 32.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A safety cinch for use with a saddle, the safety cinch comprising:
a first layer of material;
a securing device connectable to a saddle connector;
a latch apparatus that can selectively engage the securing device; and
a wireless receiver that can send a signal to the latch apparatus to disengage from the securing device to unsecure a saddle from an animal.

2. The safety cinch of claim 1 wherein the latch apparatus is secured to the first layer of material.

3. The safety cinch of claim 1 wherein the latch apparatus includes a latching mechanism that can selectively engage the securing device.

4. The safety cinch of claim 3 wherein the latch mechanism includes c-shaped brackets that are offset wherein a leg from each c-shaped bracket extends through a portion of the securing device.

5. The safety cinch of claim 1 further comprising a remote control for sending a signal to the wireless receiver to actuate the latch apparatus to disengage from the securing device and permit the safety cinch to disengage from the saddle.

6. The safety cinch of claim 1 wherein the securing device comprises:
a crown part having a lateral opening therein for engaging with the latch apparatus;
a first leg extending from the crown part and attachable to the saddle connector; and
a second leg extending from the crown part and attachable to the saddle connector.

7. The safety cinch of claim 1 wherein the securing device comprises:
a cross bar;
a first leg extending from the cross bar and attachable to the saddle connector;
a second leg extending from the cross bar and attachable to the saddle connector; and
a pin latch supported by the cross bar for engaging with the latch apparatus.

8. The safety cinch of claim 7 wherein the pin latch comprises:
an insertion end for being inserted into the latch apparatus; and
an engagement part extending from the insertion end that is narrower than a base portion of the insertion end which creates a shoulder that engages with a latching mechanism of the latch apparatus.

9. The safety cinch of claim 1 further comprising a second sheet of material to cover certain components of the safety cinch.

10. The safety cinch of claim 1 further comprising a power supply, communication link and wires connecting the wireless receiver and the latch apparatus.

11. A method of dislodging a saddle from a horse via a remote control, the method comprising:
actuating the remote control to activate a safety cinch, the safety cinch comprising:
a first layer of material;
a securing device connectable to a saddle connector;
a latch apparatus that can selectively engage the securing device; and
a wireless receiver that can send a signal to the latch apparatus to disengage from the securing device to unsecure a saddle from an animal.

12. The method of claim 11 wherein the latch apparatus is secured to the first layer of material.

13. The method of claim 11 wherein the latch apparatus includes a latching mechanism that can selectively engage the securing device.

14. The method of claim 13 wherein the latch mechanism includes c-shaped brackets that are offset wherein a leg from each c-shaped bracket extends through a portion of the securing device.

15. The method of claim 11 further comprising a remote control for sending a signal to the wireless receiver to actuate the latch apparatus to disengage from the securing device and permit the safety cinch to disengage from the saddle.

16. The method of claim 11 wherein the securing device comprises:
a crown part having a lateral opening therein for engaging with the latch apparatus;
a first leg extending from the crown part and attachable to the saddle connector; and
a second leg extending from the crown part and attachable to the saddle connector.

17. The method of claim 11 wherein the securing device comprises:
a cross bar;
a first leg extending from the cross bar and attachable to the saddle connector;
a second leg extending from the cross bar and attachable to the saddle connector; and
a pin latch supported by the cross bar for engaging with the latch apparatus.

18. The method of claim 17 wherein the pin latch comprises:
an insertion end for being inserted into the latch apparatus; and
an engagement part extending from the insertion end that is narrower than a base portion of the insertion end which creates a shoulder that engages with a latching mechanism of the latch apparatus.

19. The method of claim 11 further comprising a second sheet of material to cover certain components of the safety cinch.

20. The method of claim 11 further comprising a power supply, communication link and wires connecting the wireless receiver and the latch apparatus.
